(19) United States
(12) Patent Application Publication
(10) Pub. No.: US 2022/0097136 A1
(43) Pub. Date: Mar. 31, 2022

(54) METHODS FOR JOINING ADDITIVE MANUFACTURED PARTS

(71) Applicant: Ford Global Technologies, LLC, Dearborn, MI (US)

(72) Inventors: Michael James Freeman, Allen Park, MI (US); Edgar Edward Donabedian, Livonia, MI (US)

(73) Assignee: Ford Global Technologies, LLC, Dearborn, MI (US)

(21) Appl. No.: 17/038,246

(22) Filed: Sep. 30, 2020

(51) Int. Cl. B22F 7/06; B22F 5/10; B22F 3/105

(52) U.S. Cl. CPC B22F 7/062; B33Y 80/00; B22F 3/1055; B22F 5/10

(57) ABSTRACT

A method of joining parts includes additively manufacturing a first part in a green state. The first part defines at least one receiving feature and the method includes placing a second part into the at least one receiving feature and forming an assembly, and sintering the assembly such that volumetric shrinkage of the first part secures the second part to the first part. The first part can be binder jet additively manufactured, for example metal binder jet additively manufactured. Non-limiting examples of the at least one receiving feature include a slot, a T-shaped slot, an L-shaped slot, a key-hole slot, an aperture, a clip, a flange, and combinations thereof, and non-limiting examples of the second part include a ball stud, a T-head stud, an L-head stud, a bolt, a nut, a flange, and a bracket.

### FIELD

The present disclosure relates to joining of additive manufactured parts and particularly to joining binder jet additive manufactured parts.

### BACKGROUND

The statements in this section merely provide background information related to the present disclosure and may not constitute prior art.

Various additive manufacturing techniques or technologies are used to make parts and binder jetting, e.g., metal binder jetting, is one such additive manufacturing technique with a relatively high volume or part throughput. In addition, joining binder jet parts together or joining pre-fabricated parts to a binder jet part using traditional joining techniques such a welding can alter the microstructure and properties of the binder jet part(s).

The present disclosure addresses the issues of joining additive manufactured parts among other issues related to additive manufactured parts.

### SUMMARY

This section provides a general summary of the disclosure and is not a comprehensive disclosure of its full scope or all of its features.

In one form of the present disclosure, a method of joining parts includes additively manufacturing a first part in a green state. The first part defines at least one receiving feature and the method includes placing a second part into the at least one receiving feature and forming an assembly, and sintering the assembly such that volumetric shrinkage of the first part secures the second part to the first part. In some variations, the first part is binder jet additively manufactured, for example metal binder jet additively manufactured.

In at least one variation, the at least one receiving feature is at least one of a slot, a T-shaped slot, an L-shaped slot, a key-hole slot, an aperture, a clip, a flange, and combinations thereof. In some variations the at least one receiving feature is the key-hole slot and the second part is a stud with a head placed in a slot portion of the key-hole slot. The stud can be a threaded stud and the method can include threadingly engaging a third part onto the threaded stud. Also, a plug can be placed into a hole or bore portion of the key-hole slot and the plug and the first part are sintered together during sintering of the assembly.

In some variations, the second part is at least one of a ball stud, a T-head stud, an L-head stud, a bolt, a nut, a flange, a bracket, and combinations thereof, and the second part can be a pre-fabricated part formed using traditional manufacturing techniques or an additively manufactured part. In at least one variation the second part is an additively manufactured part and is in a green state when placed into the at least one receiving feature. In such variations the second part and the first part can be sintered together and form a monolithic part during sintering of the assembly.

In some variations, the second part is a weld flange. In such variations the method can include welding a third part to the weld flange.

In some variations, the method further includes placing an adhesive material on at least one of the first part and the second part, e.g., between the second part and the at least one receiving feature, before sintering the assembly.

In another form of the present disclosure, a method of joining parts includes metal binder jetting a plurality of first parts in a green state. The plurality of first parts each defining at least one receiving feature and a second part is placed into each of the at least one receiving features of the plurality of first parts in the green state or in a brown state to form a plurality of assembled parts. The plurality of assembled parts are sintered and each of the second parts are secured to the first parts via volumetric shrinkage of the first parts during sintering. In some variations, the at least one receiving feature is at least one of a slot, a T-shaped slot, an L-shaped slot, a key-hole slot, an aperture, a clip, a flange, and combinations thereof, and the second part is at least one of a ball stud, a T-head stud, an L-head stud, a bolt, a nut, a flange, a bracket, and combinations thereof. In at least one variation an adhesive material is placed on at least one of the second part and the at least one receiving feature before sintering the assembly.

In still another form of the present disclosure, a method of joining parts includes metal binder jetting a plurality of first parts in a green state such that each of the plurality of first parts define at least one receiving feature and racking the plurality of parts in the green state or in a brown state. A second part is placed into each of the at least one receiving features of the plurality of first parts such that a plurality of assemblies is formed and the plurality of assemblies are sintered such that volumetric shrinkage during sintering secures each of the second parts to each of the first parts. In some variations, the at least one receiving feature is at least one of a slot, a T-shaped slot, an L-shaped slot, a key-hole slot, an aperture, a clip, a flange, and combinations thereof, and the second part is at least one of a ball stud, a T-head stud, an L-head stud, a bolt, a nut, a flange, a bracket, and combinations thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a system for additively manufacturing parts by binder jetting;

FIG. 2A shows powder particles used for binder jetting;

FIG. 2B shows a microstructure of a binder jet additive manufacture part in a green state;

FIG. 2C shows a microstructure of a binder jet additive manufacture part after debinding;

FIG. 2D shows a microstructure of a binder jet additive manufacture part after sintering with infiltration;

FIG. 2E shows a microstructure of a binder jet additive manufacture part for a final sintered part;

FIG. 3A is a perspective view of a first part in a green state or a brown state with a receiving feature according to one form of the present disclosure;

FIG. 3B is a cross-sectional view of section 3B-3B in FIG. 3A in a green or brown state;

FIG. 3C is a cross-sectional view of section 3C-3C in FIG. 3A in a green or brown state;

FIG. 3D is a cross-sectional view of section 3B-3B in FIG. 3A in a final state;

FIG. 3E is a cross-sectional view of section 3C-3C in FIG. 3A in a final state;

FIG. 4A is a perspective view of the first part in FIG. 3A with a second part placed within the receiving feature;

FIG. 4B is a cross-sectional view of section 4B-4B in FIG. 4A in a green or brown state;

FIG. 4C is a cross-sectional view of section 4C-4C in FIG. 4A in a green or brown state;

FIG. 4D is a cross-sectional view of section 4B-4B in FIG. 4A in a final state;

FIG. 4E is a cross-sectional view of section 4C-4C in FIG. 4A in a final state;

FIG. 5 is a perspective view of the first part in FIG. 3A with a third part placed within the receiving feature according to another form of the present disclosure;

FIG. 6A is a perspective view of a first part in a green or brown state with two receiving features according to still another form of the present disclosure;

FIG. 6B is a perspective view of the first part in FIG. 6A in a final state with a second part secured to the first part by two receiving features;

FIG. 7A is a perspective view of a first part in a green or brown state with a receiving feature according to yet another form of the present disclosure;

FIG. 7B is a cross-sectional view of the assembly in FIG. 7A in the green or brown state and with a second part placed within the receiving feature;

FIG. 7C is a cross-sectional view of the assembly in FIG. 7A in a final state and with the second part secured to the first part by the receiving feature;

FIG. 8 is perspective view of example second parts according to the teachings of the present disclosure;

FIG. 9 is a flowchart of a method for joining a second part to a first part according to one form of the present disclosure; and

FIG. 10 is a flowchart of a method joining second parts to first parts according to another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

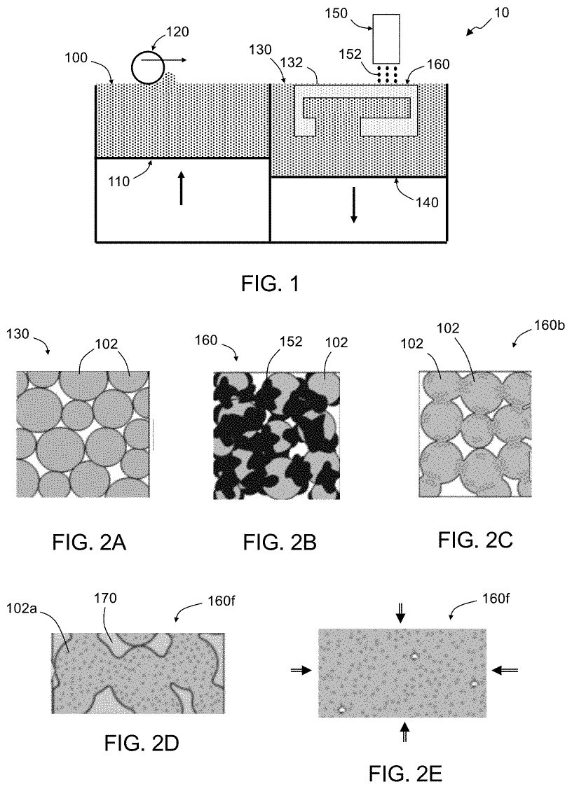

Referring to FIG. 1, a system 10 for additively manufacturing a first part 160 in a green state via binder jetting (e.g., metal binder jetting) is shown. The system 10 includes a first powder bed 100 on a first elevator platform 110 and a powder roller 120 configured to transfer powder from the first powder bed 100 to a second powder bed 130 on a second elevator platform 140. A binder nozzle 150 (e.g., an inkjet print head) is included and configured to move and deposit a liquid binder 152 at desired or selected locations across an upper surface 132 of the powder bed 130. The desired or selected locations of the upper surface 132 with powder and binder 152 form a layer (e.g., a first layer—not labeled) of the first part 160.

After the first layer is formed, the second elevator platform 140 moves downward (−z direction) and the powder roller 120 transfers powder from the first powder bed 100 to the second powder bed 130 and spreads a thin layer (not labeled) of powder across the previously formed first layer of the first part 160. And the binder nozzle 150 moves across the powder bed 130 (again) and deposits the binder 152 at desired or selected locations across the upper surface 132 of the powder bed 130 to form a second layer (not labeled) of the first part 160. This cycle, i.e., powder—binder—powder—binder, continues until the entire first part 160 is formed in a green state, layer by layer, and then the first part 160 in the green state is removed from the powder bed 130 and subjected to additional processing as described below.

As used herein the term or phrase “green state” refers to a part that has been formed but is subjected to additional processing such as debinding and/or sintering before a final part is provided. Also, used herein the term or phrase “final part” refers to a part with physical, chemical and/or mechanical properties suitable for the intended use of the par, though it is understood that the final part may be subjected to additional physical manipulation before being used such as machining, drilling, sanding, and coating, among others.

Referring to FIGS. 2A-2E, FIG. 2A shows an enlarged view of the powder particles 102 in the first powder bed 100 or the second powder bed 130, and FIGS. 2B-2E show an evolution of the microstructure for the first part 160 formed from the powder particles 102. Particularly, the microstructure of the first part 160 in the green state (FIG. 2B) includes powder particles 102 bound together with the binder 152. In some variations, the first part 160 in the green state is subjected to a debinding step or process (FIG. 2C) in which the binder 152 is removed by heat, i.e., the binder 152 is removed by vaporization and/or burning such that a “brown part” 160b is provided. In addition, the debinding can result in initial bonding or sintering at contact points between adjacent particles 102 as shown in FIG. 2C. However, it should be understood that a part in a “brown state” is subjected to additional processing such as sintering before a final part is provided.

Whether or not the first part 160 is subjected to debinding as shown in FIG. 2C, the first part 160 (or the brown part 160b) is sintered to form a final part 160f with a microstructure as shown in FIG. 2D or FIG. 2E. In some variations, a filler or infiltrant 170 is used during sintering to fill voids between sintered particles 102a (FIG. 2D) and thereby increase the density and strength of the part 160f. In other variations, pressure is applied during sintering to increase the density (and strength) of the part 160f as shown in FIG. 2E. In should be understood that an infiltrant and pressure can be used or applied during sintering.

During sintering, and particularly during sintering under pressure, densification of the microstructure results in volumetric shrinkage of the first part 160 as indicated by the double-line arrows in FIG. 2E. In addition, and according to the teachings of the present disclosure, the volumetric shrinkage is used to secure components to additive manufactured parts as described below. As used herein, the term “secure” refers to attaching one part to another part such that the attached part cannot be removed from the part to which it is attached without permanently damaging the attached part or the part to which it is attached.

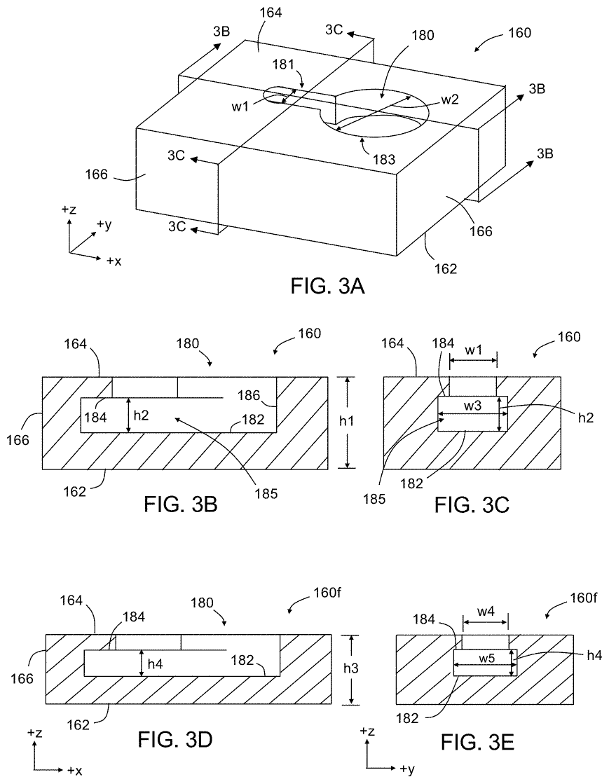

Referring to FIGS. 3A-3E, a perspective view of the first part 160 in a green or brown state is shown in FIG. 3A and volumetric shrinkage of the first part 160 resulting from sintering is depicted in FIGS. 3B-3E. The first part 160 has a lower (−z direction) surface 162, an upper surface 164, and at least one sidewall 166 extending between the lower surface 162 and the upper surface 164. The first part 160 also has a receiving feature 180 in the form of a keyhole slot with a slot portion 181 and a hole portion 183. The slot portion 181 has an inner dimension ‘w1’ and the hole portion 183 has an inner dimension ‘w2.’ The receiving feature 180 is defined by a lower surface 182, an upper surface 184, and at least one sidewall 186 extending between the lower surface 182 and the upper surface 184 (FIGS. 3B-3C). A channel portion 185 below (−z direction) the upper surface 164 and extending along the slot portion 181 is defined between the lower surface 182, the upper surface 184, and the at least one sidewall 186.

The first part 160 in the green or brown state has a height ‘h1’ between the lower surface 162 and the upper surface 164. The channel portion 185 has an inner dimension ‘w3’ between the at least one sidewall 186 (FIG. 3C), and a height ‘h2’ between the lower surface 182 and the upper surface 184 (FIG. 3B). However, and as shown in FIGS. 3D-3E, sintering of the first part 160 results in volumetric shrinkage such that a final part 160f has a height ‘h3’ less than the height h1 (h3<h1). Also the slot portion 181 of the final part 160f has an inner dimension ‘w4’ less than the inner dimension w1 (w4<w1), and the channel portion 185 has an inner dimension ‘w5’ less than the inner dimension w3 (w5<w3) and a height ‘h4’ less than height h2 (h4<h2). In some variations, the first part 160, and other first parts discussed herein, exhibit up to 30% volumetric shrinkage during sintering and densification. For example, in at least one variation the first part 160, and other first parts discussed herein, exhibit between 15-25% volumetric shrinkage.

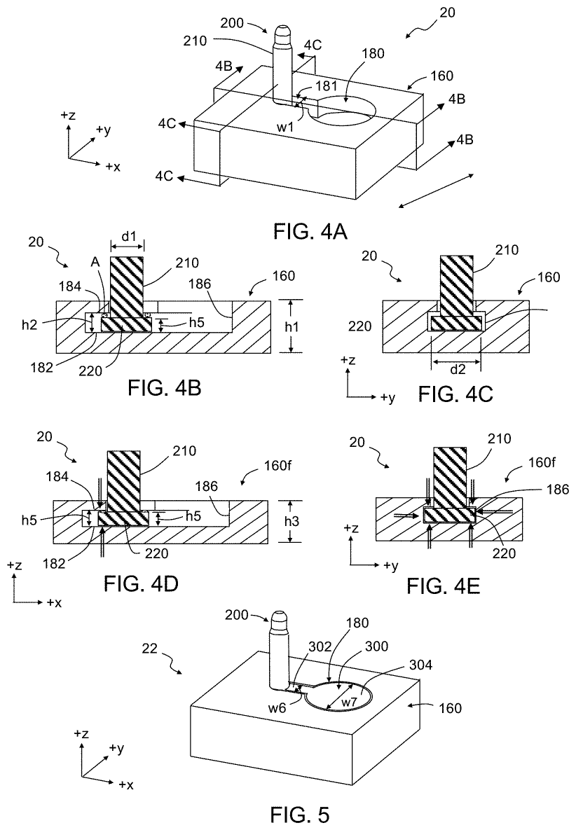

Referring to FIGS. 4A-4E, sintering of the first part 160 in the green state and using the resulting volumetric shrinkage to secure a second part to the first part 160 is depicted. Particularly, FIGS. 4A-4C show a second part 200 placed within the receiving feature 180 of the first part 160 in the green or brown state and forming an assembly 20. The second part 200 (e.g., a stud) has a shaft 210 and a head 220 attached to the shaft 210. The shaft 210 has an outer dimension d1 that is less than the inner dimension w1 (d1<w1) of the slot portion 181, and the head 220 has an outer dimension d2 that is greater than the inner dimension w1 (d2>w1) of the slot portion 181 and less than the inner dimension w3 (d2<w3) of the channel portion 185 (FIG. 3C). The head 220 also has a height ‘h5’ (FIG. 4B) that is less than the height h2 (FIG. 3B) of the channel portion 185 (h5<h2). Accordingly, the shaft 210 and head 220 can slide or be placed within the receiving feature 180 when the first part 160 is in the green or brown state.

Referring particularly to FIGS. 4D-4E, sintering of the assembly 20 results in volumetric shrinkage of the first part 160 such that the slot portion 181 of the final part 160f has the inner dimension w4 (FIG. 3E), and the channel portion 185 has the inner dimension w5 (FIG. 3E) and the height h4 (FIG. 3D). Accordingly, the volumetric shrinkage of the first part 160 results in displacement of the lower surface 182, upper surface 184, and/or the at least one sidewall 186 towards the shaft 210 and/or head 220 of the second part 200 as indicated by the arrows in FIGS. 4D-4E. And in some variations, this displacement of the lower surface 182, upper surface 184, and/or the at least one sidewall 186 binds or locks the second part 200 to the final part 160f. That is, displacement of the of the lower surface 182, upper surface 184, and/or the at least one sidewall 186 applies a force (i.e., a compressive force) onto the second part 200 such that the second part is secured to the final part 160f.

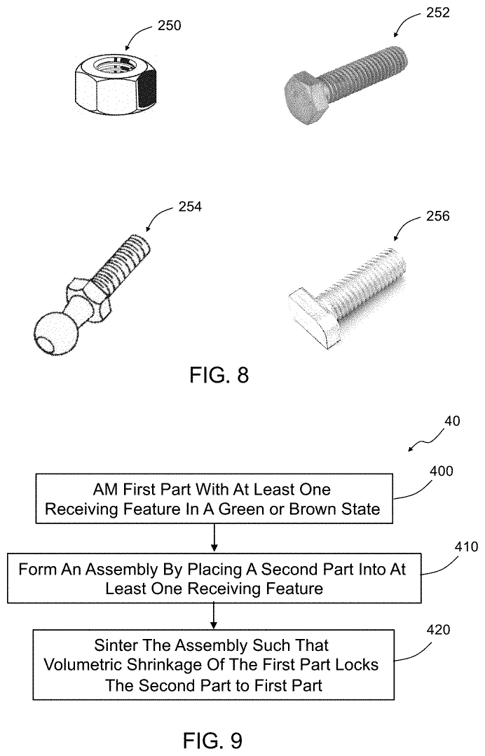

In some variations, the second part 200 is a pre-manufactured part that does not experience or experiences negligible volumetric shrinkage compared to the first part 160 during sintering. For example, the second part 200 can be an additive manufactured part that has already been sintered or a part made from a casting or wrought metal material. In other variations, the second part 200 is an additive manufactured part that has not been sintered but is made from a material that does not exhibit as much volumetric shrinkage as the first part 160. In some variations, surfaces of the first part 160 and the second part 200 in contact with each other are sintered together during sintering of the assembly 20. In at least one variation another part is attached to the second part 200 and thus to the first part 160 (and final part 160f). For example, in some variations the shaft 210 is a threaded shaft and another part, e.g., a nut 250 (FIG. 8). is threadingly engaged with the threaded shaft such that one or more additional parts or components can be attached to the sintered assembly 20. And while FIGS. 4A-4E show a stud (e.g., a bolt) secured to the final part 160f, it should also be understood that a second part with internal threads (e.g., a nut) can be secured to the final part 160f such that a threaded shaft (e.g., a bolt) can be attached to the sintered assembly 20.

In at least one variation, an adhesive, solder and/or brazing material (referred to herein simply as “adhesive”) is placed on the first part 160 and/or the second part 200 before sintering to enhance attachment of the second part 200 to the first part 160. In one non-limiting example an adhesive ‘A’ is placed between head 220 and the upper surface 184 of the receiving feature 180 as shown in FIG. 4B. Non-limiting examples of adhesive, solder and/or brazing materials include epoxies, tin-antimony alloys, tin-copper alloys, tin-silver alloys, aluminum-silicon alloys, copper, copper-silver alloys, copper-zinc alloys, copper-tin alloys, and nickel alloys, among others.

Referring to FIG. 5, a third part 300 is placed within the receiving feature 180 of the first part 160 in the green or brown state to form an assembly 22. The third part 300 has a slot portion 302 with an outer dimension ‘w6’ that is less than the inner dimension w1 of the slot portion 181 (w6<w1) and a plug portion 304 with an outer dimension ‘w7’ that is less than the inner dimension w2 of the hole portion 183 (w7<w2). And similar to securing or locking the second part 200 to the first 160, volumetric shrinkage of the first part 160 during sintering of the assembly 22 results in the at least one sidewall 186 (FIG. 4B) of the receiving feature 180 being displaced towards and compressing onto the third part 300 such that the third part 300 is secured to the final part 160f.

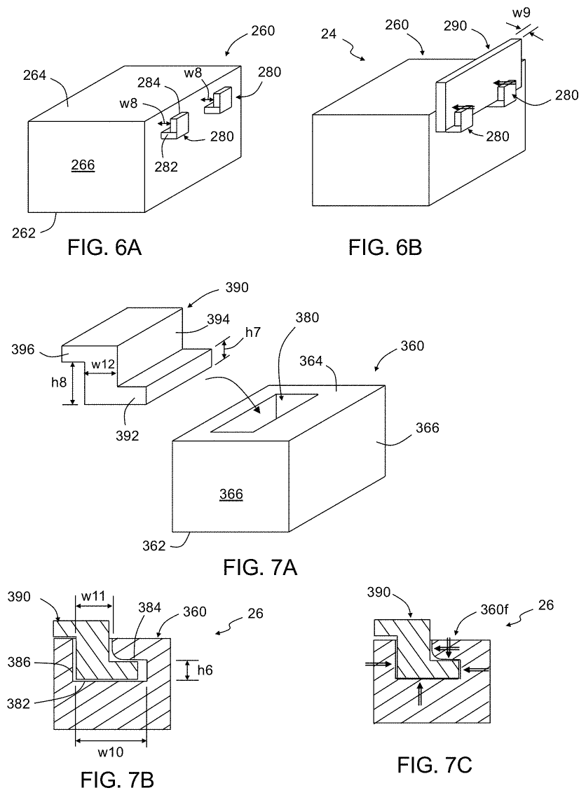

Referring now to FIGS. 6A-6B, sintering of a first part in a green or brown state and using volumetric shrinkage to secure a second part to the first part according to another form of the present disclosure is depicted. Particularly, a first part 260 has a lower (−z direction) surface 262, an upper surface 264, and at least one sidewall 266 extending between the lower surface 262 and the upper surface 264. The first part 260 also has two receiving features 280 in the form of clips. In the non-limiting example shown in FIG. 6A, the two receiving features 280 each have a first leg 282 extending from the sidewall 266 and a second leg 284 spaced apart from the sidewall 266 and extending from the first leg 282. The receiving features 280 define an opening (not labeled) with an inner dimension ‘w8’ between the sidewall 266 and the second leg 284. While both of the two receiving features 280 are shown to have the same inner dimension w8 in FIG. 6A, in some variations the two receiving features 280 have different inner dimensions.

A second part 290 with an outer dimension ‘w9’ less than the inner dimension w8 (w9<w8) is placed in the receiving features 280 of the first part 260 in the green or brown state to form an assembly 24 as shown in FIG. 6B. And similar to securing or locking the second part 200 to the first part 160 discussed above, volumetric shrinkage of the first part 260 during sintering results in the second legs 284 of the receiving features 280 being displaced towards and compressing onto the second part 290 as indicated by the double-line arrows in FIG. 6B such that the second part 290 is secured to the final part 160f. It should be understood that similar to second part 200 discussed above, the second part 290 can be a pre-manufactured part that does not experience volumetric shrinkage during sintering and/or an additive manufactured part that has not been sintered but is made from a material that does not exhibit as much volumetric shrinkage as the first part 260. It should also be understood that another part can be joined to the second part 290, e.g., via welding and/or use of screws, bolts, rivets, among others. For example, in some variations the second part 290 is a welding flange and/or a flange that is drilled or pierced. Accordingly, securing second part to a first part according to the teachings of the present disclosure provides joining of additively manufactured parts to other parts or assemblies using traditional joining techniques such as welding, screwing, and riveting, among others.

Referring now to FIGS. 7A-7C, sintering of a first part in a green state and using volumetric shrinkage to secure a second part to the first part according to still another form of the present disclosure is depicted. Particularly, a first part 360 has a lower (−z direction) surface 362, an upper surface 364, and at least one sidewall 366 extending between the lower surface 362 and the upper surface 364. The first part 360 also has a receiving feature 380 in the form of an L-shaped slot with a lower surface 382, an upper surface 384, and at least one sidewall 366 extending between the lower surface 382 and the upper surface 384. The receiving portion 380 has a first inner dimension ‘w10’, a second inner dimension ‘w11’ and a height ‘h6’ when the first part 360 is in a green or brown state. A second part 390 has a first leg 392, a wall 394 extending from the first leg 392, and a second leg 396 extending from the wall 394. The first leg 392 has a height ‘h7’ less than the height h6 (h7<h6) and the wall 394 has a height ‘h8’ and an outer dimension ‘w12’ less than the outer dimension w11 (w12<w11) such that the second part 390 is placed within the receiving feature 380 when the first part 360 is in the green or brown state and forms an assembly 26 as shown in FIG. 7B. And similar to securing or locking the second part 200 to the first part 160 discussed above, volumetric shrinkage of the first part 360 during sintering of the assembly 26 results in the lower surface 382, upper surface 384, and/or at least one sidewall 386 of the receiving feature 380 being displaced towards and compressing onto the second part 390 as indicated by the double-line arrows in FIG. 7C such that the second part 390 is secured to a final part 360f.

While FIGS. 4A-7C show second parts 200, 290, and 390 in the form of either a stud with a head or flanges, it should be understood that second parts with other shapes and attachment features are included within the teachings of the present disclosure, including but not limited to a nut 250, bolt 252, a ball stud 254, and a stud with a T-shaped head 256 as shown in FIG. 8.

Referring now to FIG. 9, a method 40 of securing or locking a second part to an additively manufactured first part is shown. The method 40 includes providing an additively manufactured first part, e.g., a metal binder jetting part, with at least one receiving feature in a green state at 400 and forming an assembly by placing a second part into the at least one receiving feature of the first part at 410. Then, the assembly is sintered at 420 such that volumetric shrinkage secures the second part to the first part as described with respects to FIGS. 2A-7C.

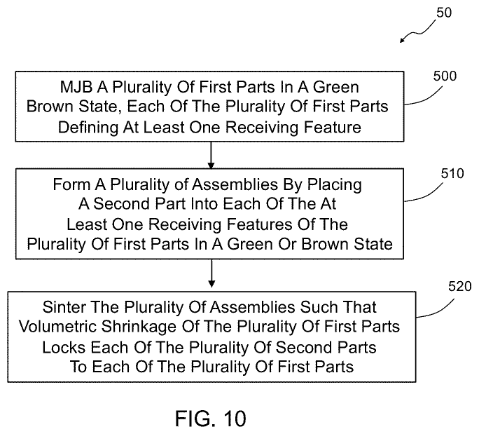

Referring now to FIG. 10, a method 50 of securing or locking a plurality of second parts to a plurality of additively manufactured first parts is shown. The method includes metal binder jetting a plurality of first parts, e.g., a plurality of metal binder jetting parts, in a green state at 500. Each of the plurality of first parts has at least one receiving feature. A plurality of assemblies are formed at 510 by placing a second part into each of the at least one receiving features. Then, the plurality of assemblies are sintered at 520 such that the volumetric shrinkage locks or secures each of the second parts to each of the plurality of first parts as described with respects to FIGS. 2A-7C.

It should be understood from the teachings of the present disclosure that a method for securing secondary parts such as fasteners, clips, flanges, among others to a first or primary part is provided. The method includes placing one or more of the secondary parts into one or more receiving features of the primary part and forming an assembly, for example during racking of a plurality of primary parts in preparation for sintering, and then sintering the assembly such that volumetric shrinkage of the primary part secures the secondary part(s) to the primary part. Also, additional parts can be joined to the secondary part, e.g., using traditional joining techniques such as welding, riveting, among others, and thereby enhance joining to, while maintaining the integrity of, additively manufactured parts. For example, joining additively manufactured parts and structures to conventional assemblies such as automotive body assemblies is enhanced by the teachings of the present disclosure.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

Unless otherwise expressly indicated, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of joining parts, the method comprising:
additively manufacturing a first part in a green state, the first part defining at least one receiving feature;
placing a second part into the at least one receiving feature and forming an assembly; and
sintering the assembly such that volumetric shrinkage of the first part secures the second part to the first part.

2. The method according to claim 1, wherein the first part is binder jet additively manufactured.

3. The method according to claim 1, wherein the first part is metal binder jet additively manufactured.

4. The method according to claim 1, wherein the at least one receiving feature is at least one of a slot, a T-shaped slot, an L-shaped slot, a key-hole slot, an aperture, a clip, a flange, and combinations thereof.

5. The method according to claim 4, wherein the at least one receiving feature is a key-hole slot and the second part is a stud with a head placed in a slot portion of the key-hole slot.

6. The method according to claim 5 further comprising placing a plug into a bore portion of the key-hole slot and forming the assembly, wherein the plug and the first part are sintered together during sintering of the assembly.

7. The method according to claim 5, wherein the stud is a threaded stud.

8. The method according to claim 7 further comprising threadingly engaging a third part onto the threaded stud.

9. The method according to claim 1, wherein the second part is at least one of a ball stud, a T-head stud, an L-head stud, a bolt, a nut, a flange, a bracket, and combinations thereof.

10. The method according to claim 9, wherein the second part is selected from the group consisting of a pre-fabricated part and an additively manufactured part.

11. The method according to claim 1, wherein the second part is an additively manufactured part and is in a green state when placed into the at least one receiving feature.

12. The method according to claim 11, wherein the second part and the first part are sintered together and form a monolithic part during sintering of the assembly.

13. The method according to claim 1, wherein the second part is a weld flange.

14. The method according to claim 13 further comprising welding a third part to the weld flange.

15. The method according to claim 13 further comprising placing an adhesive material on at least one of the second part and the at least one receiving feature before sintering the assembly.

16. A method of joining parts, the method comprising:
metal binder jetting a plurality of first parts in a green state, the plurality of first parts each defining at least one receiving feature;
placing a second part into each of the at least one receiving features of the plurality of first parts in the green state and forming a plurality of assemblies; and
sintering the plurality of assemblies, wherein volumetric shrinkage of each of the plurality of first parts secures the second part to the first part during the sintering of the plurality of assemblies.

17. The method according to claim 16, wherein the at least one receiving feature is at least one of a slot, a T-shaped slot, an L-shaped slot, a key-hole slot, an aperture, a clip, a flange, and combinations thereof, and the second part is at least one of a ball stud, a T-head stud, an L-head stud, a bolt, a nut, a flange, a bracket, and combinations thereof.

18. The method according to claim 16 further comprising placing an adhesive material on at least one of the second part and the at least one receiving feature before sintering the plurality of assemblies.

19. A method of joining parts, the method comprising:
metal binder jetting a plurality of first parts in a green state, the plurality of first parts each defining at least one receiving feature;
racking the plurality of parts in the green state or in a brown state;
placing a second part into each of the at least one receiving features of the plurality of first parts in the green state and forming a plurality of assemblies; and
sintering the plurality of assemblies, wherein volumetric shrinkage of each of the plurality of first parts secures each of the plurality of second parts to the plurality of first parts during the sintering of the plurality of assemblies.

20. The method according to claim 19, wherein the at least one receiving feature is at least one of a slot, a T-shaped slot, an L-shaped slot, a key-hole slot, an aperture, a clip, a flange, and combinations thereof, and the second part is at least one of a ball stud, a T-head stud, an L-head stud, a bolt, a nut, a flange, a bracket, and combinations thereof.
